(19) United States
(12) Patent Application Publication
(10) Pub. No.: US 2012/0316927 A1
(43) Pub. Date: Dec. 13, 2012

(54) COMPUTER-IMPLEMENTED METHOD AND APPARATUS FOR INTEGRATING HETEROGENEOUS BUSINESS PROCESSES

(75) Inventors: Feng Chen, Beijing (CN); Jin Dong, Beijing (CN); Miao He, Beijing (CN); Changrui Ren, Beijing (CN); Bing Shao, Beijing (CN); Qi Ming Tian, Beijing (CN); Qin Hua Wang, Beijing (CN)

(73) Assignee: International Business Machines Corporation, Armonk, NY (US)

(21) Appl. No.: 13/590,355

(22) Filed: Aug. 21, 2012

Related U.S. Application Data
(63) Continuation of application No. 13/451,623, filed on Apr. 20, 2012.

(30) Foreign Application Priority Data
Apr. 22, 2011 (CN) 201110111283.3

(51) Int. Cl. G06Q 10/06

(52) U.S. Cl. 705/7.36

(57) ABSTRACT

A computer-implemented method and apparatus for integrating heterogeneous business processes. In one embodiment, there is provided a computer-implemented method for integrating heterogeneous business processes, the method comprising: reading first process information of a first business process; obtaining from a unified process view second process information of a second business process; and integrating at least one part of the first process information and at least one part of the second process information into a third business process; wherein the first business process and the second business process are heterogeneous business processes. In another embodiment, there is provided a computer-implemented apparatus for integrating heterogeneous business processes.

### CROSS REFERENCE TO RELATED APPLICATION

This application is a continuation of and claims priority from U.S. application Ser. No. 13/451,623 filed on Apr. 20, 2012, which in turn claims priority under 35 U.S.C. 119 from Chinese Application 201110111283.3, filed Apr. 22, 2011, the entire contents of both applications are incorporated herein by reference.

### BACKGROUND OF THE INVENTION

1. Field of the Invention

Embodiments of the present invention relate to business process management, and more particularly, to a computer-implemented method, apparatus, and relevant computer program product for integrating heterogeneous business processes.

2. Description of the Related Art

The development of computer technology provides many conveniences for everyday life. At present, various kinds of computer hardware and software products have been developed for automatically organizing and managing operation processes that were previously performed manually. For example, the evolution of business process management (BPM) provides an application for automatically implementing an operation flow. In addition to helping enterprises perform business process analysis, BPM also utilizes computer technology to automate processes that were previously performed manually, such as file transfer.

At present, many software providers have developed various application products for business process management, for example, applications dedicated to business processes such as applying for a business trip, applying for booking flight tickets, and applying for reimbursement, etc., but these applications usually have only a single function and an exclusive objective. During their development processes, however, most enterprises use products available from a plurality of software providers to manage the business processes of their enterprises. For example, an enterprise may use an application from IBM™ for managing the business process of applying for a business trip, use an application from Oracle™ for managing the business process of applying for booking flight tickets, and use an application from SAP™ for managing a process of applying for reimbursement. Such processes based on technical implementations of different providers are referred to as “heterogeneous business processes” in this specification.

Because these three applications are from different providers and their formats are incompatible, users cannot extend these applications to other processes that are not dedicated business processes as designed. Nowadays no solution is provided for integrating heterogeneous business processes from a plurality of providers, and users have to separately develop dedicated tools for integrating heterogeneous business processes of particular types or purchase applications that may provide the desired business processes. Both solutions will cause additional overhead as previously purchased applications have to be replaced with new applications. It is difficult to reuse resources, thus, wasting an existing investment.

### BRIEF SUMMARY OF THE INVENTION

In order to overcome these deficiencies, the present invention provides a computer-implemented method of integrating heterogeneous business processes, including: reading first process information of a first business process; obtaining second process information of a second business process from a unified process view; and integrating at least one part of the first process information and at least one part of the second process information into a third business process; wherein the first business process and the second business process are heterogeneous business processes.

According to another aspect, the present invention provides a computer-implemented apparatus for integrating heterogeneous business processes, including: reading means configured to read first process information of a first business process; obtaining means configured to obtain second process information of a second business process from a unified process view; and integrating means configured to integrate at least one part of the first process information and at least one part of the second process information into a third business process; wherein the first business process and the second business process are heterogeneous business processes.

### BRIEF DESCRIPTION OF THE SEVERAL VIEWS OF THE DRAWINGS

Features, advantages, and other aspects of various embodiments of the present invention will become more apparent through the following detailed description with reference to the following drawings, wherein:

FIG. 1 schematically illustrates a diagram of a method of integrating heterogeneous business processes according to one solution;

FIG. 2 schematically illustrates a diagram of a method of integrating heterogeneous business processes according to one embodiment of the present invention;

FIGS. 3A and 3B schematically illustrate data structures of data source metadata and process resource metadata, respectively;

FIGS. 4A to 4C schematically illustrate examples of process models associated with heterogeneous business processes;

FIG. 5 schematically illustrates the operation of a method of integrating heterogeneous business processes according to one embodiment of the present invention;

FIG. 6 schematically illustrates a process model of a business process subsequent to the integration according to one embodiment of the present invention, the business process being integrated with the heterogeneous business processes corresponding to the process models of FIGS. 4A and 4B;

FIG. 7 schematically illustrates a process model of a business process subsequent to the integration according to another embodiment of the present invention, the business process being integrated with the heterogeneous business processes corresponding to the process models of FIGS. 4A to 4C; and

FIG. 8 schematically illustrates a block diagram of an apparatus of integrating heterogeneous business processes according to one embodiment of the present invention.

### DETAILED DESCRIPTION OF THE PREFERRED EMBODIMENTS

Hereinafter, various embodiments of the present invention will be described in detail with reference to the drawings.

The flowcharts and block diagrams in the figures illustrate the system, methods, as well as architecture, functions and operations executable by a computer program product according to embodiments of the present invention. In this regard, each block in the flowcharts or block diagrams may represent a module, a program segment, or a part of code, which contains one or more executable instructions for performing specified logic functions. It should be noted that, in some alternative implementations, the functions noted in the blocks may also occur in a sequence different from what is noted in the drawings. For example, two blocks shown consecutively can be performed substantially in parallel or in an inverse order. This depends on relevant functions. It should also be noted that each block in the block diagrams and/or flowcharts and a combination of blocks in the block diagrams and/or flowcharts can be implemented by a dedicated hardware-based system for performing specified functions or operations or by a combination of dedicated hardware and computer instructions.

Hereinafter, the principle and spirit of the present invention will be described with reference to various exemplary embodiments. It should be understood that provision of these embodiments is only to enable those skilled in the art to better understand and further implement the present invention, and is not intended for limiting the scope of the present invention in any manner.

It should be noted that the business process in this invention refers to an operation flow dedicated to a certain transaction during the operation process of an enterprise (for example, the business process of applying for a business trip, the business process of applying for reimbursement, etc.). The business process can be implemented based on the technologies of different corporations, for example, implemented in IBM™ DB format, Oracle™ DB format, or SAP™ format. In the embodiments of the present invention, the process information refers to a process flow described with a particular format. For example, if the process flow of applying for a business trip is implemented based on the IBM™ DB format, then the data that are described in the dedicated IBM™ DB format are called the process data of the business process of “applying for business trip.”

For example, three business processes may exist: applying for a business trip, applying for booking flight tickets, and applying for reimbursement. Now, the meaning of business process will be illustrated only with the business process of applying for a business trip as an example. For example, an enterprise stipulates that an applicant for business trip should complete an application form for a business trip, submit the form to the department manager for approval, and then submit the application form for the business trip that has been signed by the department manager to the general manager for approval, and finally submit the application form for the business trip that has been signed by both the department manager and the general manager to the finance manager for approval, wherein the applicant can only take the trip after the approval of the finance manager. The above is a typical business process. For example, the business process of applying for a business trip can be implemented based on the IBM™ DB format.

Similarly, the business process of applying for booking flight tickets can be as such: an applicant submits the application form for a business trip that has been signed by the above three managers together with the application form for flight tickets to the department manager for approval; after the department manager signs the application form for flight tickets, the applicant further submits the application form for flight tickets to the general manager and the finance manager in sequence; and only after the three managers have signed the application form for flight tickets can the applicant book the flight ticket. Now, although the three managers do not need to sign the application form for the business trip again, the application form for the business trip has been signed by the three managers triggers the business process of applying for booking the flight ticket, thus the application form for the business trip is further required in the business process of applying for booking flight tickets. For example, the business process of applying for booking flight tickets can be implemented based on the Oracle™ DB format.

Similarly, the application form for a business trip and the application form for flight tickets that have been signed by the three managers respectively are premises for triggering the business process of applying for reimbursement, and the applicant is further required to fill in the application form for reimbursement to be submitted to the three managers for approval, which will not be detailed here. For example, the business process of applying for reimbursement can be implemented based on the SAP™ format.

Because the above three exemplary business processes are heterogeneous business processes, it is necessary to separately develop a transformation tool for the respective two business processes during the procedure of integrating these business processes into a general business process (namely including the business processes of applying for business trip, applying for booking flight tickets, and applying for reimbursement).

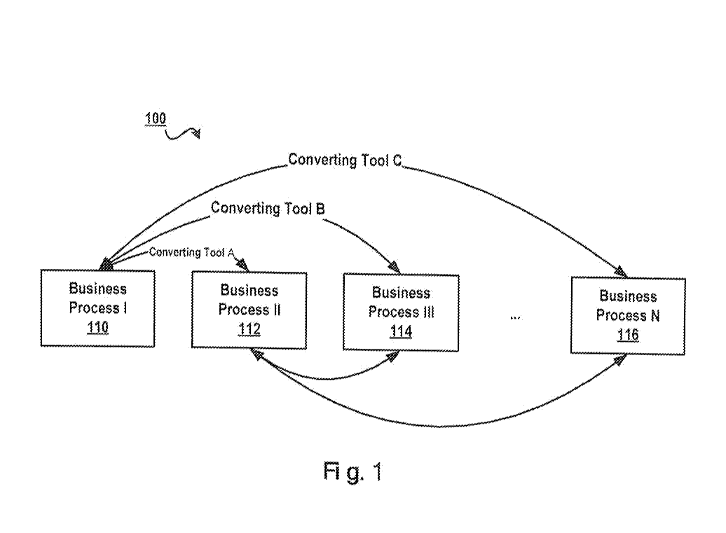

FIG. 1 schematically illustrates a diagram 100 of a method of integrating heterogeneous business processes according to one solution. The heterogeneous business processes as illustrated in FIG. 1 include business process I 110, business process II 112, business process III 114, and business process N 116. When it is desired to integrate the business processes into one business process, it is required to develop a plurality of converting tools, for example, the converting tool A between the business process I 110 and the business process II 120, the converting tool B between the business process I 110 and the business process III 114, and the converting tool C between the business process I 110 and the business process N 116, etc.

Embodiments of the present invention provide a computer-implemented method of integrating heterogeneous business processes. The method may overcome the drawbacks in the traditional operation to separately develop converting tools dedicated to integrating two heterogeneous business processes, thereby providing a method of integrating heterogeneous business processes based on a unified process view.

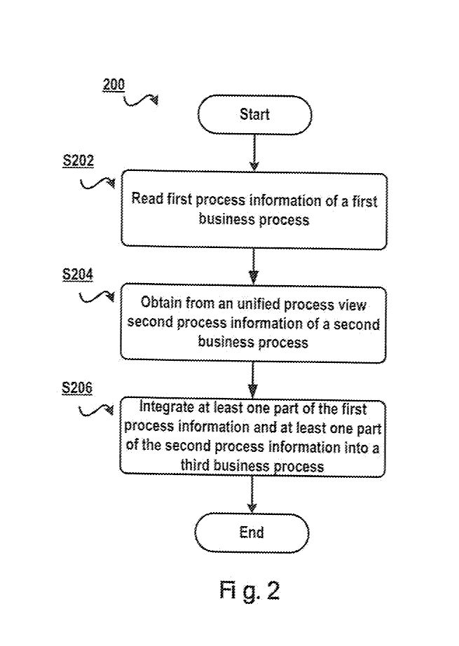

FIG. 2 schematically illustrates a diagram 200 of a method of integrating heterogeneous business processes according to one embodiment of the present invention. First, at step S202, the first process information of a first business process is read. The first business process here can be a business process of applying for business trip as previously mentioned, and the first process information can be the information described in the IBM™ DB format. It should be noted that various embodiments of the present invention provide a method of integrating heterogeneous business processes. The method may first read a business process and take this business process as a main body, and then integrate at least one part of another business process into this main body. The first business process here can be located locally in a computer that implements the method according to this embodiment or remotely at a location other than this computer.

At step S204, the second process information of a second business process is obtained from a unified process view. For example, the second business process here can be a business process of applying for booking flight tickets that is implemented based on the Oracle™ DB technology. It should be noted that although the second business process is implemented based on the Oracle™ DB technology, the second process information here is described in the same data format as the first process information (namely, described in the IBM™ DB format), and the second process information here is the converted process information obtained in the unified process view, which will be described later.

When the first business process and the second business process are homogeneous business processes, namely, when the two business processes are described in the same format (for example, IBM™ DB format), the prior solution may implement an integration of the two business processes, which is therefore not considered in the present invention. In embodiments of the present invention, the first business process and the second business process are heterogeneous business processes.

At step S206, at least one part of the first process information and at least one part of the second process information are integrated into a third business process. The third business process here can be a business process that is homogeneous or heterogeneous to any of the first business process and the second business process, and the first business process and the second business process are heterogeneous business processes.

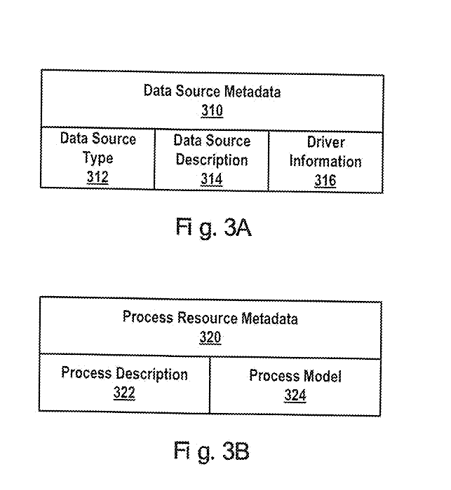

In one embodiment, before obtaining the second process information of the second business process, the unified process view is further provided with a pre-processing operation. Hereinafter, reference is first made to FIGS. 3A and 3B, which illustrate data structures involved in the pre-processing operation, and then various steps of the pre-processing operation are explained. FIGS. 3A and 3B schematically illustrate data structures of data source metadata 310 and process resource metadata 320, respectively.

The data source metadata 310 as illustrated in FIG. 3A refers to the information that describes process resources, namely the information describing the source of the business process. As illustrated in FIG. 3A, the data source metadata 310 includes at least one of data source type 312, data source description 314, and driver information 316. In one embodiment, the data source metadata 310 can include the data source type 312, data source description 314, and driver information 316. The data source type 312 here refers to the type of the business process, for example, the type based on the IBM™ DB format, the type based on the Oracle™ DB format, or the type based on the SAP™ format. Embodiments of the present invention perform different operations based on different data source types 312.

The data source description 314 refers to the general description of the business process. This description varies with different data source types 312. For example, for the business process based on the SAP™ format, the data source description 314 includes: IP, user name, password, client number, system name, system number, etc. For the business process based on the IBM™ DB format, the data source description 314 can include: IP, connection description, schema, user name, password, etc.

In order to implement integration of the heterogeneous business processes, embodiments of the present invention define a unified format, while the driver information 316 refers to the information that describes how to mutually convert between the format of a business process itself and the unified format. For example, it can include the name of a class that is used in implementing the driver information and the parameter list of the involved methods, etc. The driver information 316 has different contents for different data source types. For example, for the business process based on the SAP™ format, the driver information 316 can include the function name, parameter lists of the function, etc. Here, the driver information can be provided by a provider of a particular data source type, or developed by a user itself based on an interface specification provided by the provider.

FIG. 3B illustrates a data structure of a process resource metadata 320. The process resource metadata refers to the information that describes process resources, which, as illustrated in FIG. 3B, can include two portions: process description 322 for summarizing the overall condition of the process, which for example can include a unified resource identifier of the process, the data source metadata identifier and state, etc.; and process model 324, which for example can include at least one of activity, connection, and private data. In one embodiment, the process model 324 can include an activity, connection, and private data. It should be noted that the process model has a unified format, and such a unified formatted process model forms a unified process view.

After specifying the specific meanings of the data structures as illustrated in FIGS. 3A and 3B, the above pre-processing operation can be better understood. The pre-processing operation is substantively to convert, based on the data source metadata and the process resource metadata, heterogeneous business processes into a process model that has a unified format in the unified process view, that is to say, obtaining a process model in a process resource metadata associated with the heterogeneous business processes.

In one embodiment, before obtaining from the unified process view the second process information of the second business process, a pre-processing operation is further provided. The pre-processing operation, for example, includes first registering the data source metadata of the second business process with a unified process view. One of the objectives of registering here is to inform the unified process view of how to locate the second business process and how to obtain the required information from the second business process. Next, process resource metadata of the second business process is obtained based on the data source metadata. The process resource metadata can be easily obtained based on the data source type, data source description, and driver information as included in the data source metadata. It should be noted that the process resource metadata includes a process description and a process model.

In one embodiment, obtaining from the unified process view the second process information of the second business process includes obtaining from the process resource metadata the second process information of the second business process. In one embodiment, obtaining from the process resource metadata the second process information of the second business process includes converting the process model in the process resource metadata into second process information that is described in the format of the first process information. One of the objectives of providing a unified process view lies in presenting heterogeneous business processes in a unified format. In order to perform an integrating operation in the same format in the next step, it is further necessary to convert a process model that is described in a unified format into second process information that is described in the format of the first process information.

In one embodiment, the process model includes at least one of activity, connection, and private data. The activity is for describing the specific operation steps in the business process; the connection refers to the sequential relationship in time between two activities, which sequential relationship is defined as “connection”; the private data refers to the data required during the period of performing one activity to the next activity, i.e., data associated with the connection.

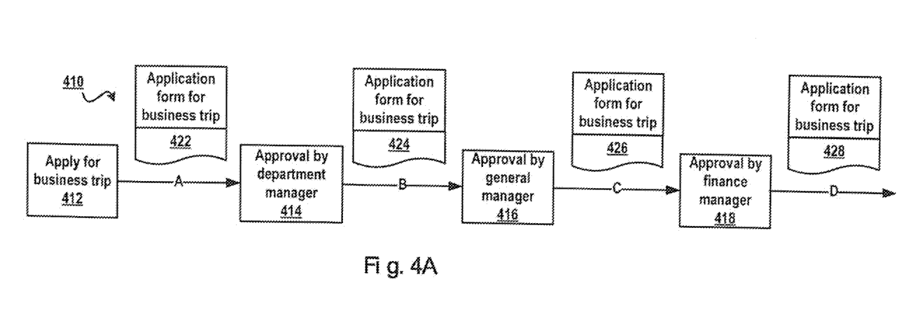

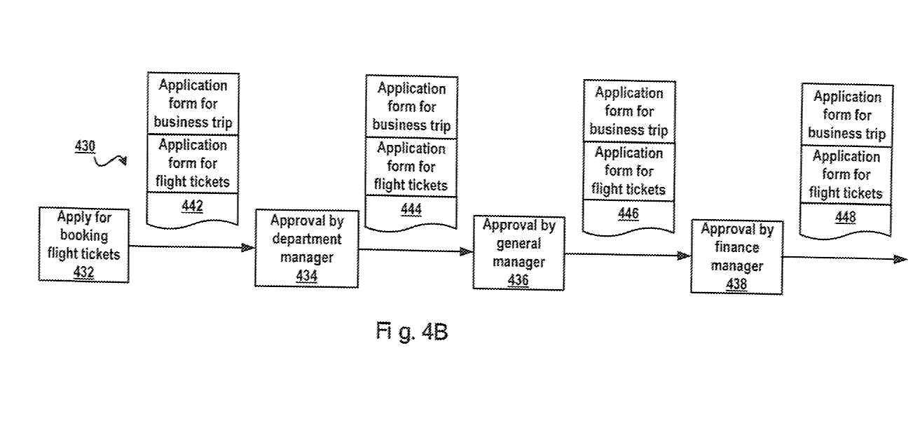

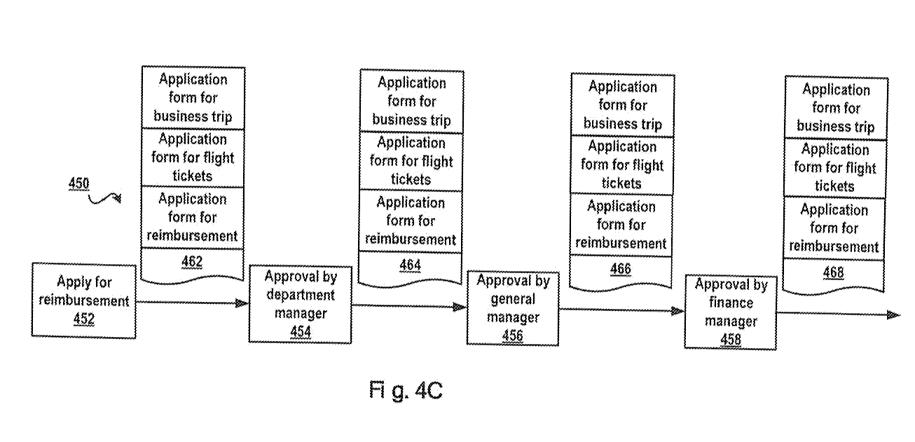

Hereinafter, a process model associated with the heterogeneous business processes will be described in detail with reference to FIGS. 4A to 4C. FIGS. 4A to 4C schematically illustrate an exemplary diagram of process models for implementing heterogeneous business processes of different operations. For example, process models 410, 430, and 450 corresponding to the following three business processes, respectively: the business process of applying for business trip that is implemented based on the IBM™ DB format, the business process of applying for booking flight tickets that is implemented based on the Oracle™ DB format, and the business process of applying for reimbursement that is implemented based on the SAP™ format. By using a method according to one embodiment of the present invention, process models that are described in a unified format can be obtained based on the data source metadata and process resource metadata of the business process, for example, process models 410, 430, and 450 as illustrated in FIGS. 4A to 4C.

Hereinafter, the meanings of process models as illustrated in FIGS. 4A to 4C will be briefly explained. For the process model 410 as illustrated in FIG. 4A, the activity includes: applying for business trip 412, approval by department management 414, approval by general manager 416, and approval by finance manager 418; arrows A, B, C, and D indicate the “connection” between two temporally successive activities. The application form for business trip 422, 424, 426, and 428 are private data associated with connections A, B, C, and D, respectively. For example, the application form for business trip 422 indicates that after applying for business trip 412, it is required to submit the application form for business trip 422, so as to perform the activity “approval by department manager 414.”

As illustrated in the business process 410, the activity 412 illustrates a step of applying for business trip. At this point, the applicant needs to submit the application form for business trip 422; and then at step 414, the department manager approves the application form for business trip 422 and signs on the form, where the application form for business trip has been signed by the department manager is indicated as 424. Next, at the activity 416, the general manager approves and signs on the application form for business trip 424 that has been signed by the department manager, thereby obtaining the application form for business trip 426 that has been signed by the department manager and the general manager. Finally, after approval by the finance manager as illustrated by the activity 418, an application form for business trip 428 that has been signed by the department manager, the general manager, and the finance manager is obtained.

FIG. 4B illustrates another business process 430 of applying for booking flight tickets. One premise of executing this business process is that booking flight tickets can only be applied for after the applicant has obtained the application form for business trip that has been signed by the three managers. The business process 430 is similar to the business process 410. The applicant applies for booking flight tickets at step 432. The submitted documents 422 include an application form for flight tickets and the application form for business trip that has been signed by the department manager, general manager, and finance manager. Next, at the activity 434, the department manager approves and signs the application form for flight tickets. Thereby an application form for flight tickets that has been signed by the department manager is obtained. At the activity 436, the general manager approves, and at the activity 438, the finance manager approves. Thereafter, the application form for flight tickets that has been signed by the three managers is obtained. At this point, although the application form for the business trip that has been signed by the three managers is not changed in the business process 430, this application form for business trip is also essential.

FIG. 4C illustrates another business process 450 of applying for reimbursement. One premise of executing this business process is that reimbursement can only be applied for after the applicant has obtained the application form for the business trip and the application form for flight tickets that have been signed by the three managers, respectively. The activities 452, 454, 456, and 458 as illustrated in the business process 450 and meanings of private data 462, 464, 466, and 468 are similar to those of the business process 430, which will not be detailed here.

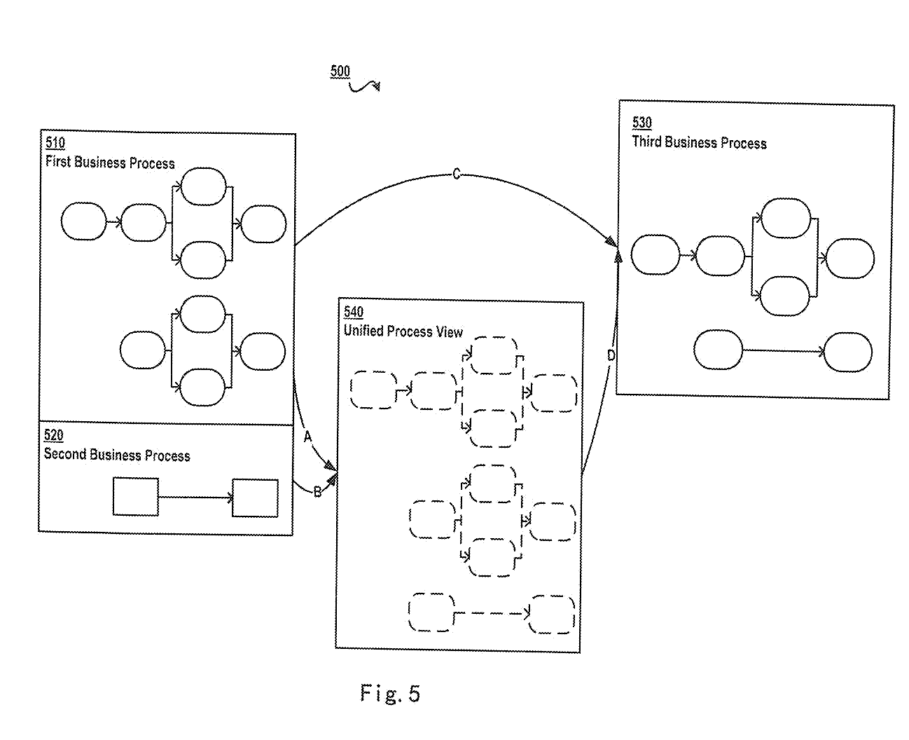

FIG. 5 schematically illustrates the operation 500 of a method of integrating heterogeneous business processes according to one embodiment of the present invention. In one embodiment, in the pre-processing step as mentioned above, first, process models that are described in a unified format can be stored into a unified process view. For example, respective homogeneous or heterogeneous business processes are converted into process models in the unified format and stored into the unified process view, and the unified process view can be taken as a unified resource pool that is available for a subsequent integrating operation.

As illustrated by arrows A and B in FIG. 5, the first business process 510 and the second business process 520 can be converted from their original data formats into process models in the unified format. For example, the first business process 510 can be a business process for applying for a business trip based on the IBM™ DB format, while the second business process 520 can be a business process for applying for booking flight tickets based on the Oracle™ DB format. FIG. 5 illustrates flow charts of the first business process 510 and the second business process 520 in an oval and a rectangle, respectively. One objective is to indicate that the two business process can be of different types, namely, they can be based on different formats.

Through the pre-processing operations as illustrated by arrow A and arrow B, process models that are described in the unified format (illustrated in dotted line) can be obtained from the first business process 510 and the second business process 520 and stored into the unified process view 540. Next, the operation as illustrated by arrow C corresponds to reading first process information of the first business process at step S202, while the operation of the arrow D corresponds to obtaining the second process information of the second business process from the unified process view at step S204, and the third business process 530 illustrated in FIG. 5 is a third process model that is obtained from integrating at least one part of the first process information and at least one part of the second process information. It should be noted that although the third business process 530 and the first business process 510 show their respective flow charts in an oval, in one embodiment, the format of the third business process 530 can be different from that of the first business process 510 or the second business process 520.

In one embodiment, integrating at least one part of the first process information and at least one part of the second process information into the third business process includes: editing at least one part of the first process information and at least one part of the second process information to form an intermediate process model; submitting to the unified process view the intermediate process model; and in response to the intermediate process model having been confirmed, forming the third business process.

It should be noted that because the integrating procedure is actually a procedure of modifying the original first business process and second business process to form a new business process, it is necessary to edit the original business processes according to the requirement by the third business process. The editing procedure can be executed at the computer that reads the first business process, and the intermediate process model can be in the format of the first process information.

Next, an intermediate process model is submitted to the unified process view. This submitting procedure can be detailed into uploading the intermediate process model to the unified process view, and converting the intermediate process model that is described in the format of the first process information into a process model that is supported by the unified process view, namely, converted into a process model that is described in the unified format. Because the unified process view itself has no editing function, it is further required to return the process model associated with the intermediate process model to a tool that develops the second business process, so as to confirm (for example, by the user) whether the intermediate process model that is formed during the integrating procedure complies with a rule in the first business process. Next, in response to the intermediate process model having been confirmed, a third business process is formed.

During the period of forming the intermediate process model, because the first process information and the second process information have been possibly modified, one objective of the confirming operation at this point is to validate whether the above amendment is “legal.” If the first process information of the first business process has been modified, because this modification is executed locally by the computer that opens the first business process, whether the modification is legal is validated locally by the computer. Because the second process information of the second business process is obtained from the unified process view, it would be impossible to validate locally by the computer whether the modification to the second process information is legal.

In one embodiment, forming the third business process in response to the intermediate process model having been confirmed includes: determining a change of the intermediate process model with respect to a process model of the second business process; synchronizing the change into the second business process; and in response to the change having been successfully synchronized into the second business process, generating the third business process.

One objective of determining a change of the intermediate process model with respect to a process model of the second business process lies in determining the data that have been changed due to the integrating operation through comparing the intermediate model with the original process model that is associated with the second business process, such that it is only required to confirm whether the changed data are legal in the next step. Because the unified process view does not provide a confirming function, it is further required to synchronize the change into the second business process and to make further confirmation (for example, by the user) in a tool that develops the second business process.

Next, if the change has been successfully synchronized to the second business process, it is deemed that the change is legal or can be adjusted in a tool that develops the second business process to make the change legal, thereby forming the third business process. If a new modification to the second business process is introduced during the adjusting procedure, the new modification is further required to be transmitted to the computer that performs the integrating operation via a unified process view, so as to form the third business process.

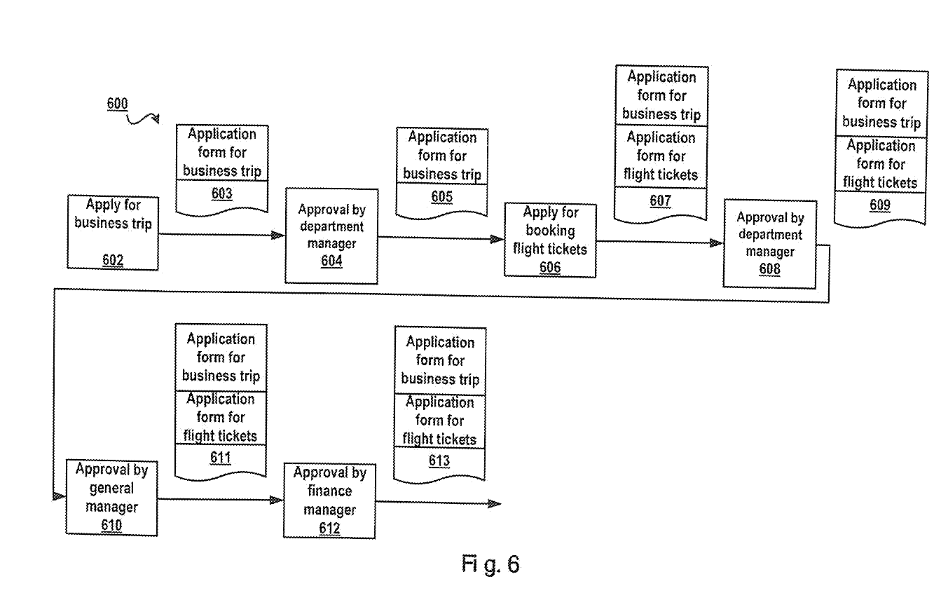

FIG. 6 schematically illustrates an example of a business process after the integration according to one embodiment of the present invention, the business process being integrated with the heterogeneous business processes corresponding to the process models of FIGS. 4A and 4B.

Referring back to FIGS. 4A and 4B, for different process models 410 and 430, the activities 414 and 434 are both for approval by the department manager, thus the content of the two activities per se is identical. The difference lies in the objects of the activities. In activity 414, the object that is required to be approved is the application form for business trip 422, while in activity 434, the object 442 that is required to be approved includes the application form for flight tickets and the application form for the business trip that has been signed by three managers. Further, the activities 416 and 436 are both for approval by the general manager, and the activities 418 and 438 are both for approval by the finance manager. At this point, they are similar to the activities 414 and 434. From the perspective of resource reuse, the activities, connections and private data in the two process models 410 and 430 can be recombined and integrated into an integrated process model.

As illustrated in FIG. 6, the integrated process model may include activities 602 to 612, and the private data corresponding to each connection between the activities are 603 to 613, respectively. At this point, the process model of the business trip is integrated with the process model of booking flight tickets, and the objective that must be originally implemented in two business processes can be implemented only by operating the integrated process model.

It should be noted that, compared with the process model as illustrated in FIG. 4B, in the integrated process model 600, the application form for the business trip in respective private data is the internal data of the integrated process model and visible to relevant activities. In the processes as illustrated in FIGS. 4A and 4B, however, the application form for the business trip in the private data 422 is the output data of the business trip process model 410 and inputted into the process model 430 for booking flight tickets.

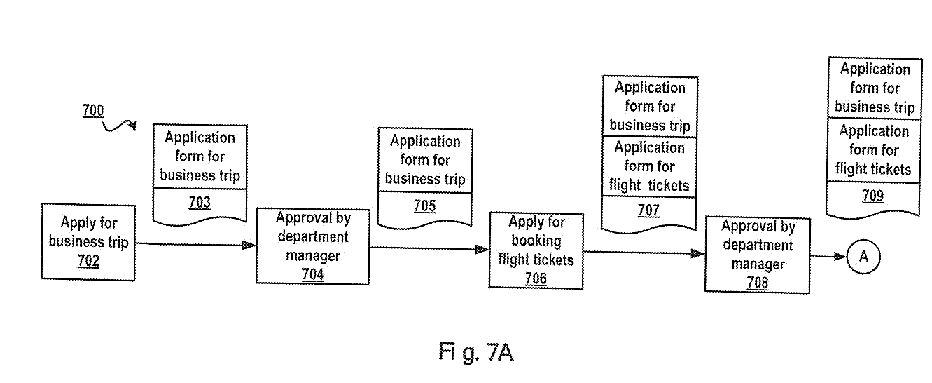

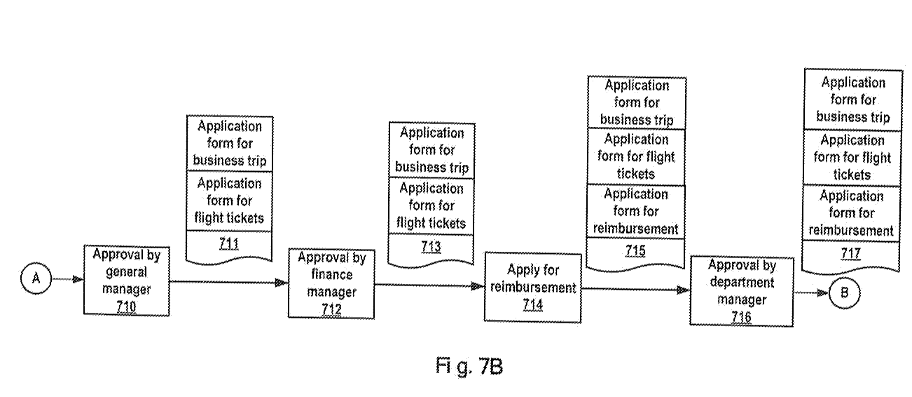

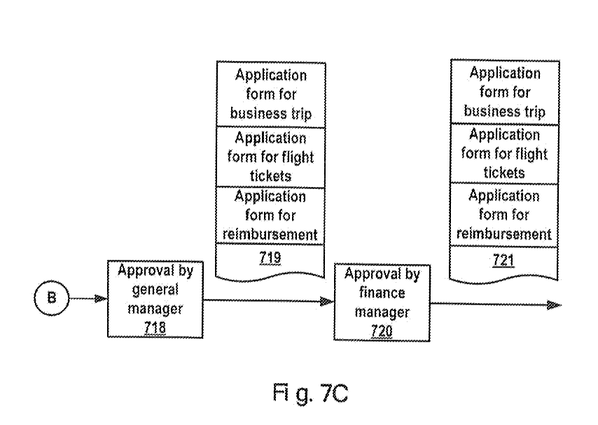

In one embodiment, a plurality of business processes can be integrated into one business process. FIGS. 7A to 7C schematically illustrate examples of integrated business processes after the integration according to another embodiment of the present invention, the business processes being integrated with the heterogeneous business processes corresponding to the process models of FIGS. 4A to 4C. The process model 700 as illustrated in FIGS. 7A to 7C is further integrated with the reimbursement process model 450 as illustrated in FIG. 4C on the basis of the process model 600 in FIG. 6 (as indicated by reference signs 714 to 721). Those skilled in the art can obtain the process model 700 of FIGS. 7A to 7C with respect to the embodiment of FIG. 6 with reference to the aforementioned, which will not be detailed here.

In one embodiment, utilizing the third business process to update the unified process view can be further provided. Because one objective of the unified process view is to provide a resource pool of process models for the user to select, when forming a new business process, it is further possible, as above mentioned, to extract a process model that is described in a unified format based on the data source metadata and process resource metadata of the new business process, and to store the process model into the unified process view, so as to subsequently be used by other users.

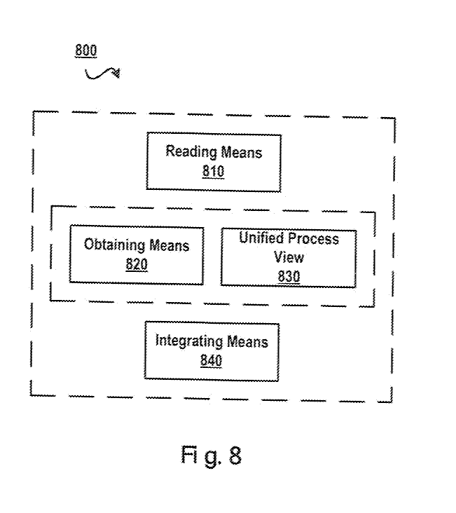

In another embodiment, there is provided a computer-implemented apparatus for integrating heterogeneous business processes. Referring to FIG. 8, the apparatus includes: reading means 810 configured to read first process information of a first business process; obtaining means 820 configured to obtain from a unified process view second process information of a second business process; and integrating means 840 configured to integrate at least one part of the first process information and at least one part of the second process information into a third business process; wherein the first business process and the second business process are heterogeneous business processes.

In one embodiment, the computer-implemented apparatus for integrating heterogeneous business processes further includes: registering means configured to register data source metadata of the second business process with the unified process view; and process resource metadata obtaining means configured to, based on the data source metadata, obtain process resource metadata of the second business process, wherein the process resource metadata include a process description and a process model.

In one embodiment, the obtaining means 820 includes: process information obtaining means configured to obtain from the process resource metadata the second process information of the second business process.

In one embodiment, the process information obtaining means includes: converting means configured to convert the process model in the process resource metadata into second process information that is described in a format of the first process information.

In one embodiment, the data source metadata include a data source type, data source description, and driver information.

In one embodiment, the process model includes at least one of activity, connection, and private data.

In one embodiment, the data source metadata include a data source type, data source description, and driver information.

In one embodiment, the process model includes an activity, connection, and private data.

In one embodiment, the integrating means includes: editing means configured to edit at least one part of the first process information and at least one part of the second process information to form an intermediate process model; submitting means configured to submit to the unified process view the intermediate process model; and forming means configured to, in response to the intermediate process model having been confirmed, form the third business process.

In one embodiment, the forming means includes: change determining means configured to determine a change of the intermediate process model with respect to a process model of the second business process; synchronizing means configured to synchronize the change into the second business process; and generating means configured to, in response to the change having been successfully synchronized into the second business process, generate the third business process.

In one embodiment, the computer-implemented apparatus for integrating heterogeneous business processes further includes: updating means configured to update the unified process view using the third business process.

It should be noted that the method and apparatus according to various embodiments of the present invention are particularly suitable for integrating the heterogeneous business processes, thereby reusing the existing business processes to the utmost and further achieving the objective of reducing costs.

The present invention may adopt a form of a hardware embodiment, software embodiment or an embodiment including hardware components and software components. In an embodiment, the present invention is implemented as software, including, without limitation to, firmware, resident software, micro-code, etc.

Moreover, the present invention can be implemented as a computer program product usable from computers or accessible by computer-readable media that provide non-transient program code for use by or in connection with a computer or any instruction executing system. For the purpose of description, a computer-usable or computer-readable medium can be any tangible means that can contain, store, communicate, propagate, or transport the program for use by or in connection with an instruction execution system, apparatus, or device.

The medium can be an electric, magnetic, optical, electromagnetic, infrared, or semiconductor system (apparatus or device), or propagation medium. Examples of the computer-readable medium would include the following: a semiconductor or solid storage device, a magnetic tape, a portable computer diskette, a random access memory (RAM), a read-only memory (ROM), a hard disk, and an optical disk. Examples of the current optical disk include a compact disk read-only memory (CD-ROM), compact disk-read/write (CR-ROM), and DVD.

A data processing system adapted for storing or executing non-transient program code would include at least one processor that is coupled to a memory element directly or via a system bus. The memory element can include a local memory usable during actually executing the non-transient program code, a mass memory, and a cache that provides temporary storage for at least one portion of non-transient program code so as to decrease the number of times for retrieving code from the mass memory during execution.

An Input/Output or I/O device (including, without limitation to, a keyboard, a display, a pointing device, etc.) can be coupled to the system directly or via an intermediate I/O controller.

A network adapter may also be coupled to the system such that the data processing system can be coupled to other data processing systems, remote printers or storage devices via an intermediate private or public network. A modem, a cable modem, and an Ethernet card are merely examples of a currently usable network adapter.

It is to be understood from the foregoing description that modifications and alterations can be made to the respective embodiments of the present invention without departing from the true spirit of the present invention. The description in the present specification is intended to be illustrative and not limiting. The scope of the present invention is limited by the appended claims only.

What is claimed is:

1. A computer-implemented method of integrating heterogeneous business processes, comprising:
reading first process information of a first business process;
obtaining second process information of a second business process from a unified process view; and
integrating at least one part of said first process information and at least one part of said second process information into a third business process;
wherein said first business process and said second business process are heterogeneous business processes.

2. The method according to claim 1, wherein before obtaining said second process information, the method further comprises:
registering data source metadata of said second business process with said unified process view; and
obtaining process resource metadata of said second business process based on said data source metadata,
wherein said process resource metadata include a process description and a process model.

3. The method according to claim 2, wherein obtaining said second process information comprises:
obtaining from said process resource metadata said second process information of said second business process.

4. The method according to claim 3, wherein obtaining from said process resource metadata said second process information of said second business process comprises:
converting said process model in said process resource metadata into second process information that is described in a format of said first process information.

5. The method according to claim 2, wherein said data resource metadata comprises at least one of a data source type, a data source description, and driver information.

6. The method according to claim 2, wherein said process model comprises at least one of an activity, a connection, and private data.

7. The method according to claim 1, wherein integrating at least one part of said first process information and at least one part of said second process information into said third business process comprises:
editing at least one part of said first process information and at least one part of said second process information to form an intermediate process model;
submitting said intermediate process model to said unified process; and
forming said third business process in response to said intermediate process model having been confirmed.

8. The method according to claim 7, wherein in response to said intermediate process model having been confirmed, forming said third business process comprises:
determining a change of said intermediate process model with respect to a process model of said second business process;
synchronizing said change into said second business process; and
wherein said change is successfully synchronized into said second business process, generating said third business process.

9. The method according to claim 1, further comprising updating said unified process view using said third business process.

10. A computer-implemented apparatus for integrating heterogeneous business processes, comprising:
reading means configured to read first process information of a first business process;
obtaining means configured to obtain second process information of a second business process from a unified process view; and
integrating means configured to integrate at least one part of said first process information and at least one part of said second process information into a third business process;
wherein said first business process and said second business process are heterogeneous business processes.

11. A computer program product for integrating heterogeneous business processes, the computer program product comprising:
a computer readable storage medium having computer readable non-transient program code embodied therein, the computer readable program code comprising:
computer readable program code configured to perform the steps of a method according to claim 1.
